(19) United States
(12) Patent Application Publication
(10) Pub. No.: US 2015/0095196 A1
(43) Pub. Date: Apr. 2, 2015

(54) Method for Identifying Replacement Parts and Extracting Features Via a Sequence of Images

(71) Applicants: Jewel Burks, Atlanta, GA (US); Nashlie Sephus, New York, NY (US); Jason Crain, New York, NY (US); Troy Nunnally, Atlanta, GA (US)

(72) Inventors: Jewel Burks, Atlanta, GA (US); Nashlie Sephus, New York, NY (US); Jason Crain, New York, NY (US); Troy Nunnally, Atlanta, GA (US)

(21) Appl. No.: 14/502,831

(22) Filed: Sep. 30, 2014

Related U.S. Application Data
(60) Provisional application No. 61/884,680, filed on Sep. 30, 2013.

(51) Int. Cl. G06Q 30/06; G06F 17/30

(52) U.S. Cl. CPC G06Q 30/0627; G06F 17/30256; G06F 17/3025; G06F 17/30262; G06F 17/30259
USPC 705/26.63

(57) ABSTRACT

A method for identifying replacement parts includes receiving a sequence of images of a test part. A set of features of the test part is extracted from the sequence of images. The features include at least one of a dimension, a shape, a texture, a color, a material, a thread count, a spectral characteristic, a histogram threshold, scale invariant features, and keypoint features. The set of features of the test part are compared with a database of a plurality of replacement parts. The database stores a set of features of each of the plurality of replacement parts. At least one replacement part is identified in the database, which has a set of features similar to the set of features of the test part. The identified replacement parts are filtered based on priority. A priority list of replacement parts is developed, and is communicated to a user.

### CROSS REFERENCE TO RELATED APPLICATIONS

This application claims priority and benefit of U.S. Provisional Application No. 61/884,680, filed Sep. 30, 2013, and entitled “Method for Identifying Replacement Parts and Extracting Features via a Sequence of Images”, the entire disclosure of which is incorporated by reference herein.

### BACKGROUND

Mechanical machines, particularly those operating in industrial settings, are periodically maintained to keep the machines running efficiently. The parts included in such machines such as, for example, rivets, screws, bolts, nuts, washers, and the likes often break or wear out, and have to be replaced. Conventionally, the replacing of such parts involves identification of the part by a user (e.g., a maintenance personnel), searching for replacements parts in supplier catalogs or online and then selecting a replacement part which best matches the part to be replaced based on the users judgment. This is often a very tedious task which can take a substantial amount of time. For example, the serial or identification numbers on the parts to be replaced are often illegible or have worn out making it difficult to identify the part. Furthermore, searching for the replacement part through multiple supplier catalogs can take a long time leading to delay in replacement of the part and thereby, operation of the machine.

### SUMMARY

Embodiments described herein relate generally to systems, methods, and computer-readable media for identifying replacement parts using imaging, and particularly to identification of replacement parts using extracted features from a sequence of images of a part to be replaced. In some embodiments, a method for identifying replacement parts includes capturing a sequence of images of a test part. A set of features of the test part is extracted from the sequence of images. The set of features include at least one of a dimension, a shape, a texture, a color, a material, a thread count, a spectral characteristic, a histogram threshold, scale invariant features, and keypoint features. The set of features of the test part are compared with a database of a plurality of replacement parts. The database stores a set of features of each of the plurality of replacement parts. At least one replacement part is identified in the database, which has a set of features similar to the set of features of the test part. The identified replacement parts are filtered based on priority. A priority list of replacement parts is developed, and is communicated to a user. In some embodiments, the extracted set of features includes a dimension, a shape, and a material. In some embodiments, the test part is at least one of a screw, a nut, and a bolt, and the extracted set of features includes a thread count.

The foregoing summary is illustrative only and is not intended to be in any way limiting. In addition to the illustrative aspects, implementations, and features described above, further aspects, implementations, and features will become apparent by reference to the following drawings and the detailed description.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1 is a block diagram of a system for identifying replacement parts and extracting a set of features of a test part via a sequence of images, according to an embodiment.

FIG. 2 is a schematic flow diagram of an exemplary method for extracting features of a test part via a sequence of images and identifying replacement parts, according to an embodiment.

FIG. 3 is a schematic flow diagram of an exemplary method for extracting features of a test part via a sequence of images and identifying replacement parts using hierarchical comparison, according to an embodiment.

FIG. 4 is a block diagram of a computing device in accordance with an embodiment.

FIG. 5A shows a first image of a blunt head screw captured from the side to show the thread count and including a penny in the image as a reference object for extracting the set of features of the screw. FIG. 5B shows a second image of the blunt head screw of FIG. 5A captured from the front to show the head of the screw, which can be used to determine the head type of the screw.

FIG. 6 is front perspective view of a machine for capturing images of a batch of replacement parts, according to an embodiment.

FIG. 7 is a front view of the machine of FIG. 6.

FIGS. 8-10 are various views of the machine of FIG. 6 showing a plurality of imaging devices included in the machine.

FIG. 11 is a back perspective view of the machine of FIG. 6.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to systems, methods, and computer-readable media for identifying replacement parts using imaging, and particularly to identification of replacement parts using extracted features from a sequence of images of a test part which is to be replaced. Embodiments described herein provided several advantages over conventional systems and methods for identifying replacement parts including, for example: (1) web crawling and scraping to build a vast database of a set of features of replacement parts from a plurality of suppliers; (2) identifying a set of features of the test part from a sequence of images of the test part such that a user does not have to provide any information of the test part; (3) storing information of the replacement parts in a database as a “bag of word” format instead of images of the replacement parts, reducing memory needs, and substantially improving the speed and scalability of the database; (5) multidimensional identification of the test part using a set of features; and (6) adaptive learning database providing learning capability for new replacement parts that are not already included in the database.

As used herein, the term “test part” refers to any part which is to be replaced.

As user herein, the term “feature” or “features” refers to a physical attributes of a part such as dimension, shape, texture, color, thread count, or any other physical attribute, as well as a computational attribute such as, spectral characteristic, histogram threshold, or any other computational attribute.

As used herein, the singular forms “a”, “an” and “the” include plural referents unless the context clearly dictates otherwise. Thus, for example, the term “a member” is intended to mean a single member or a combination of members, “a material” is intended to mean one or more materials, or a combination thereof.

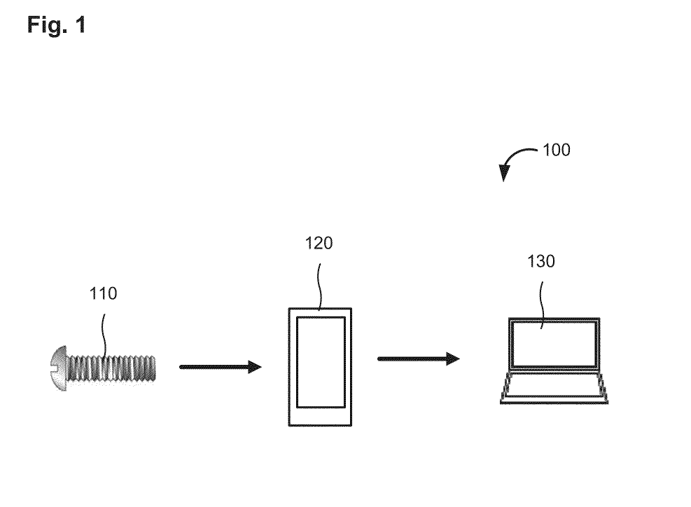

FIG. 1 is a block diagram of a system 100 for identifying replacement parts and extracting features via a sequence of images of a test part 110. While shown as being an oval head screw, the test part 110 can include any part which is to be replaced. For example, the test part 110 can include a screw (e.g., a flat head screw, a round head screw, a Phillips head screw, an oval head screw, blunt pan head screw, pointed pan head screw, socket screw, set screw, etc.), a bolt (e.g., a hex bolt, a carriage bolt, a lag bolt, an eye bolt, an elevator bolt, a U-bolt, a J-bolt, a shoulder bolt, etc.), a rivet, a nut (e.g., a hex nut, a heavy hex nut, a nylon insert lock nut, a jam nut, a wing nut, a cap nut, an acorn nut, a flange nut, a tee nut, a square nut, a torque lock nut, etc.), a washer (e.g., a flat washer, a fender washer, a finishing washer, a split lock washer, an external tooth lock washer, an internal tooth lock washer, a square washer, etc.), or any other test part that is to be replaced.

The system 100 includes an imaging device 120 operable to capture a sequence of images of the test part 110. The imaging device 120 can include, for example, a smart phone or a tablet with an integrated camera, or a camera (e.g., a digital camera). The sequence of images can include multiple images of the test part 110 captured from multiple angles by the imaging device 120. For example, in some embodiments in which the test part 110 is a screw, or a bolt, the sequence of images can include a side view of the test part 110 which captures the thread count, a front head view of the test part 110 which captures the shape and type of the screw head, and a bottom tip view which captures the type of tip (e.g., blunt, chamfered, pointed, etc.) and radius of the screw. In some embodiments, the imaging device 120 can be used to capture a video of the test part 110, for example, a 3-dimensional video. In some embodiments, the image or video of the test part 110 can be captured on a solid background, for example, a white back ground. This can, for example, facilitate extraction of a set of features of the test part 110, as described herein. The set of features can include, for example, a dimension (e.g., length, width, radius, etc.), shape, texture, color, a thread count, a spectral characteristic, a histogram threshold, scale invariant features (e.g., Scale Invariant Feature Transform (SIFT), Speed-up-Robust Feature (SURF), etc.), and/or keypoint features (e.g., Binary Robust Invariant Scalable Keypoints (BRISK), Fast Retina Keypoint (FREAK), Binary Robust Independent Elementary Features (BRIEF), Oriented Fast, and Rotated BRIEF (ORB), etc.). Moreover, in some embodiments, a reference object having known shape, dimensions, color, and/or texture (e.g., a penny) can also be included in the sequence of images or otherwise video of the test part 110. In such embodiments, the reference object serves as a reference having known features which can be correlated to the image of the test part 110 to extract the features of the test part 110 with high fidelity.

The imaging device 120 is operably coupled to a computing device 130. The computing device 130 can include any suitable computing device such as, for example, a smart phone, a tablet, a laptop, a desktop, a local server, or a remote server. In some embodiments, the imaging device 120 and the computing device 130 can be included in a single device which can be configured to capture image of the test part 110 as well as identify replacement parts such as. For example, the computing device 130 can include a smartphone, a tablet, or a computer which includes a camera (i.e., the imaging device) for capturing the image of the test part 110.

The computing device 130 is configured to store a database of a set of features of a plurality of replacement parts. The database stored in the computing device 130 can include details of a set of features of a plurality of replacement parts in a ‘bag of words” format (i.e., information in text form e.g., in a group of tables without any figures). This can save memory requirements of the database as well as allowing faster data recovery from the database in relatively short amounts of time. In some embodiments, the computing device 130 can be configured to populate the database of the plurality of replacement parts. For example, the computing device 130 can be configured to crawl, scour, or otherwise skim a plurality of websites of suppliers of one or more of the replacement parts. The computing device 130 can then scrape or otherwise obtain information corresponding to the set of features of one or more of the replacement parts from each of the plurality of websites. In some embodiments, the set of features of one or more replacement parts can be manually entered into the database. For example, information on the set of features of replacement parts that are not available from suppliers websites can be manually entered into the database.

In some embodiments, the set of features of the replacement parts can be added to the database in a batch. For example, a plurality of images of a batch of replacement parts can be captured using an imaging device, for example, the imaging device 120 (e.g., a smart phone camera, a tablet camera, a digital camera, or any other imaging device). The plurality of images of the batch of replacement parts can then be communicated (e.g., uploaded) to the computing device 130 which can then extract the set of features of the batch of replacement parts.

In some embodiments, images of a plurality of replacement parts can be batch or otherwise bulk uploaded into the computing device 130 for extracting the set of features using an automated machine (e.g., the machine 500 described herein) that includes a plurality of imaging devices. The plurality of imaging devices (e.g., cameras) can be disposed at predetermined locations in the automated machine and oriented to capture a plurality of images of the replacement parts disposed in the machine from various angles or otherwise directions. The plurality of images can then be used to extract the set of features of the replacement parts. Furthermore, the machine can include one or more conveyor belts on which the replacement parts can be placed for passing through the machine.

In some embodiments, models of the replacement parts can be trained using images of replacement parts and/or super vector features, which can be Gaussian Mixture Models (GMMs), Convolutional Neural Networks (CNNs), Radial Basis Functions (RBFS), and/or other kernels and a classifier, such as Support Vector Machines (SVMs) and/or Linear Discriminant Functions, can be constructed. The classifier can include, for example, a hierarchical classifier which can order or otherwise arrange the set of features of the replacement part into in predetermined classes or hierarchy. The set of features of the replacement parts can include information on shape, texture, color, material, thread count, a html link to at least one supplier, information on usability, and/or image (e.g., a thumbnail image). In some embodiments, the replacement parts can also be classified into hierarchical classifiers based on type in the database. For example, the replacement parts can be classified into a first-level classification as a fastener, or another part. If the replacement part is a fastener, a second-level classification can be performed to classify the replacement part as a fastener with a head, or a round a fastener. If the replacement part is a fastener with a head, a third-level classification can be performed to classify the replacement part as a screw, a bolt, or a rivet. Alternatively, if the replacement part is a round fastener, the third-level classification can classify the replacement part as a nut or a washer. Further classifications can also be performed based on the set of features of the replacement parts. Classifying the replacement parts can facilitate identification of one or more replacement parts having a set of features similar to the set of the features of the test part using hierarchical comparison, as described herein.

The computing device 130 is configured to receive the sequence of images of the test part 110 from the imaging device 120. The computing device 130 can receive the sequence of images from the imaging device 120 using any suitable means, for example, a hard wired connection, BLUETOOTH®, low power BLUETOOTH®, Wi-Fi, via a local area network (LAN), a wide area network (WAN), or the internet.

The computing device 130 can include algorithms or otherwise set of instructions operable to extract the set of features of the test part from the sequence of images of the test part. The instructions can be stored on a non-transitory computer-readable medium such as, for example, a magnetic hard drive, a solid-state drive, a CD ROM, a DVD ROM, or the likes. The set of features can include a dimension, shape, texture, color, thread count, spectral characteristic, and/or a histogram threshold of the test part. For example, in some embodiments, the algorithm or otherwise set of instructions can include a Hough Transform (e.g., circular Hough Transform, Kernel-based Hough Transform), any other suitable image processing technique, or a combination thereof. In some embodiments, the algorithms or otherwise set of instructions can be operable to use a reference object (e.g., a penny) included in the sequence of images to determine dimensions, shape, texture, color, or any other feature of the test part 110, as described herein.

In some embodiments, the test part 110 can be a screw, a nut, or a bolt. In such embodiments, the set of features extracted by the computing module 130 can include a dimension (e.g., length, diameter of head, diameter of body, etc.), a shape (e.g., round, hexagonal, etc.), a material (e.g., aluminum, copper, brass, stainless steel, etc.) and a thread count of the test part 110.

The computing device 130 is configured to compare the set of features of the test part 110 with the database of the set of features of each of the plurality of replacement parts. In some embodiments, the computing device 130 can be configured to compare the set of features of the test part 110 with the database of the set of features of the replacement parts using hierarchical comparison. In such embodiments, the set of features of the test part 110 can also be arranged by the computing device 130 in a predetermined hierarchy, similar to the hierarchical classification of the replacement parts. For example, a first-level hierarchical classification can determine whether the test part 110 is a fastener, or some other part. If the test part 110 is a fastener, a second-level classification can determine if the test part 110 is a fastener with a head or a round fastener. Furthermore, a third-level classification can determine if the test part 110 is a screw, a bolt or a rivet (if the second-level classification determined the test part 110 to be a fastener with a head), or the test part 110, is a nut or a washer (if the second-level classification determined the test part 110 to be a round fastener). Further sub-level classifications can include, shape of head, length, color, material, thread count, texture, and so on. In this manner, the computing device 130 can be configured to hierarchically compare the set of features of the test part 110 with the set of features of the replacement parts which can be already classified using a similar hierarchy in the database, as described herein.

In some embodiments, once the first-level, second-level, and/or third level hierarchical classifications are performed, comparison of the set of features of the extracted from the test part 110 do not have to be compared with the set of features of the replacement part to obtain a match. Furthermore, new replacement parts added to the database may not have to be trained to database (i.e., hierarchical classification performed on new part) if it belongs to any one of the classifications already determined by the system 100. In this manner, the hierarchical classification can decrease the comparison time by rapidly excluding parts that do not fall within the hierarchical classifications identified for the test part 110. Furthermore, extensive training or extraction of a set of features of a new replacement part might not have to be performed if it already belongs to any one of the hierarchical classifications already defined by the system 100. This is particularly helpful when parts are scraped from suppliers' websites which only provide textual information on a replacement part's properties but do not include an image of the replacement part.

The computing device 130 identifies at least one replacement part in the database having a set of features similar to the set of features of the test part 110. In some embodiments, the computing device 130 can be configured to use heuristics to determine one or more replacement parts that have a set of features best matching the set of features of the test part 110. In some embodiments, the dimensions of the test part 110 and the replacement parts can be in units that do not match. For example, the computing device 130 can extract dimension of the test part 110 in SI units, while the dimensions of the replacement part are in inches. In such embodiments, the computing device 130 can be configured to use a standard deviation to determine the closest match taking into account any error associated with computer vision metrology.

The computing device 130 can filter all identified replacement parts based on priority. For example, any duplicate replacement parts identified in the database can be filtered such that only one replacement part from each supplier is included. Expanding further, to filter the identified replacement parts based on priority, the computing device 130 can determine if more than one supplier of an identified replacement part is found. The computing device 130 can then select only a priority supplier of the identified replacement part to be included in a priority list, as described herein, and remove the rest of the suppliers from the priority list. The priority supplier can include, for example, a supplier which is contractually obligated, provides lowest rates, is reputable, and/or is located in a geographically preferred location.

The computing device 130 develops the priority list of the identified replacement parts. In some embodiments, the computing device 130 can develop the priority list by sorting the identified replacement parts to include identified replacement parts that have a set of features that best match the set of features of the test part 110, to be arranged on top of the priority list. For example, certain features included in the set of features of the replacement part can be more relevant or pertinent in finding a replacement part for the test part 110. For example, the thread counts, length, and width of a test part that includes a screw (also referred to as “the test screw”) can have higher priority relative to the size or shape of the head of the screw. Thus, replacement screws having thread counts, length, and/or width similar to the test screw will have higher priority over replacement screws that have a similar head to the test screw.

The priority list can then be communicated to a user. For example, the computing device 130 can include a display (e.g., a monitor, a smartphone screen, or a tablet screen) configured to display the priority list of the replacement parts to the users. In some embodiments, the computing module 130 can be configured to display only the top one, two, or three replacement parts that were the closest match to the test part 110 to the user. In such embodiments, the computing device 130 can provide the user with an interface, for example, a check box, pull down menu, or button to allow the user to view the other replacement parts included in the priority list.

In some embodiments, no replacement part can be identified in the database having a set of features similar to the test part 110, by the computing module 130. In such embodiments, the set of features of the test part 110 can be added to the database. Moreover, in some embodiments, the computing module 130 can allow the user to manually enter information corresponding to the test part 110 in the database, for example, set of features, supplier information, etc. In some embodiments, the computing module 130 can determine that the set of features of the identified replacement part stored in the database are less than the set of features of the test part. In such embodiments, the remaining set of features of the test part can also be added to the database.

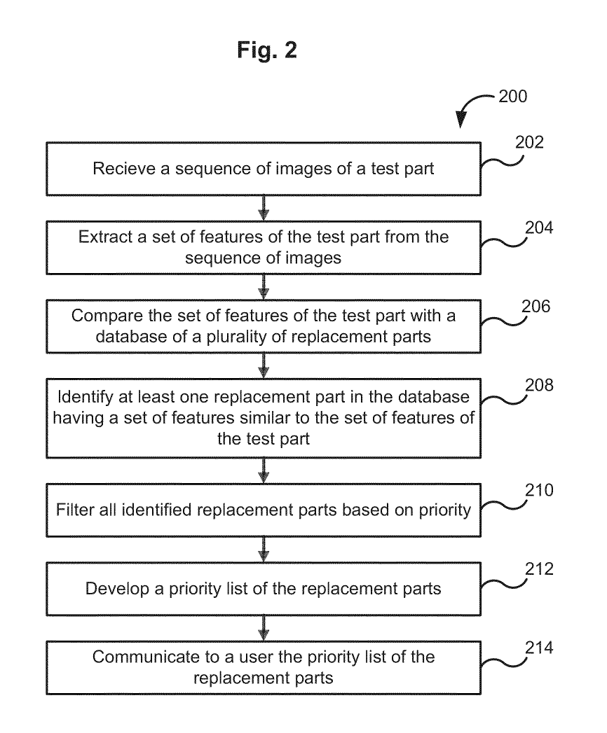

FIG. 2 shows a schematic flow diagram of an exemplary method 200 for identifying a replacement part. The method 200 can be used with any system described herein, for example, the system 100, or, a non-transitory computer readable medium capable of being executing by a computing device, for example, the computing device 130, or 430. The method 200 includes receiving a sequence of images of a test part, at 202. The test part can include a screw, a bolt, a rivet, a nut, a washer, or any other test part, as described herein with respect to the test part 110. The sequence of images can be captured using any image capture device, for example, a smart phone, a tablet, a camera, or any other image capture device as described with respect to the imaging device 120 included in the system 100. The sequence of images can include a plurality of images captured from different angles to show different views of the test part. In some embodiments, the sequence of images can include a video of the test part, for example, a 3-dimensional video, or a video captured from different angles.

A set of features of the test part are extracted from the sequence of images, at 204. The set of features can include a dimension, a shape, a texture, a color, a material, a thread count, a spectral characteristic, a histogram threshold, scale invariant features (e.g., Scale Invariant Feature Transform (SIFT), Speed-up-Robust Feature (SURF), etc.), and/or keypoint features (e.g., Binary Robust Invariant Scalable Keypoints (BRISK), Fast Retina Keypoint (FREAK), Binary Robust Independent Elementary Features (BRIEF), Oriented Fast, and Rotated BRIEF (ORB), etc.). In some embodiments, in which the test part is a screw, a nut, or a bolt, the extracted set of features can at least include a dimension, a shape, a material, and a thread count of the test part. In some embodiments, the sequence of images can include an object having a known shape, dimension, color, and texture (e.g., a penny). The object can serve as a reference object for extracting the set of features of the test part.

The set of features of the test part can extracted using a computing device, for example, the computing device 130 included in the system 100, or any other computing device described herein (e.g., the computing device 430 described herein). For examples instructions can be stored on a non-transitory computer readable medium which can be executed by a computing device (e.g., the computing device 130, or 430, as described herein) for extracting the set of features of the test part. For example, the set of features of the test part can extracted using a Hough Transform. Furthermore, any number of instructions can be stored on the non-transitory computer readable medium described herein, for performing any of the operations described herein.

The set of features of the test part are compared with a database of a plurality of replacement parts, at 206. The database stores a set of features of the replacement parts. In some embodiments, the method 200 can also include populating the database of the plurality of replacement parts. The database can be populated by crawling a plurality of websites of suppliers of one or more of the replacement parts, and scraping information corresponding to the set of features of one or more of the replacement parts from each of the plurality of websites. In some embodiments, the set of features of the replacement parts included in the database can include a shape, a texture, a color, a material, a thread count, a html link to at least one supplier, information on usability, and an image (e.g., a thumbnail image).

The method 200 identifies at least one replacement part in the database having a set of features similar to the set of features of the test part, at 208. For example, heuristics can be used to determine one or more replacement parts that have a set of features best matching the set of features of the test part. In some embodiments, the dimensions of the test part and the replacement parts can be in units that do not match. For example, the computing device 130 can extract dimension of the test part in SI units, while the dimensions of the replacement part are in inches. In such embodiments, the computing device can be configured to use a standard deviation to determine the closest match taking into account any error associated with computer vision metrology. If no replacement is discovered in the database, the set of features of the test part can be added to the database. In some embodiments, the set of features of the identified replacement part stored in the database can be less than the set of features of the test part. In such embodiments, the remaining features of the test part can be added to the database.

All identified parts are filtered based on priority, at 210. This can include, for example, determining if more than one supplier of an identified replacement part is found, and selecting only a priority supplier of the identified replacement part to include in a priority list, as described herein.

A priority list of replacement parts is developed, at 212. This can include, for example, sorting the identified replacement parts to include replacement parts having a set of features that best match the set of features of the test part to be arranged on top of the priority list. For example, certain features included in the set of features of the replacement part can be more relevant or pertinent in finding a replacement for the test part. For example, the thread counts, length, and width of a test part that includes a screw (also referred to as “the test screw”) can have higher priority relative to the size or shape of the head of the test screw. Thus, replacement screws having thread counts, length, and/or width similar to the test screw will have higher priority over replacement screws that have a similar head to the test screw.

The priority list of the replacement parts is communicated to a user, at 214. For example, the priority list of the replacement parts can be communicated to the user on a display (e.g., a monitor, a smartphone screen, or a tablet screen). In some embodiments, the top one, two, or three replacement parts that were the closest match to the test part to the user can be displayed to the user. In such embodiments, the display can include an interface, for example, a check box, pull down menu, or button to allow the user to view the other replacement parts included in the priority list.

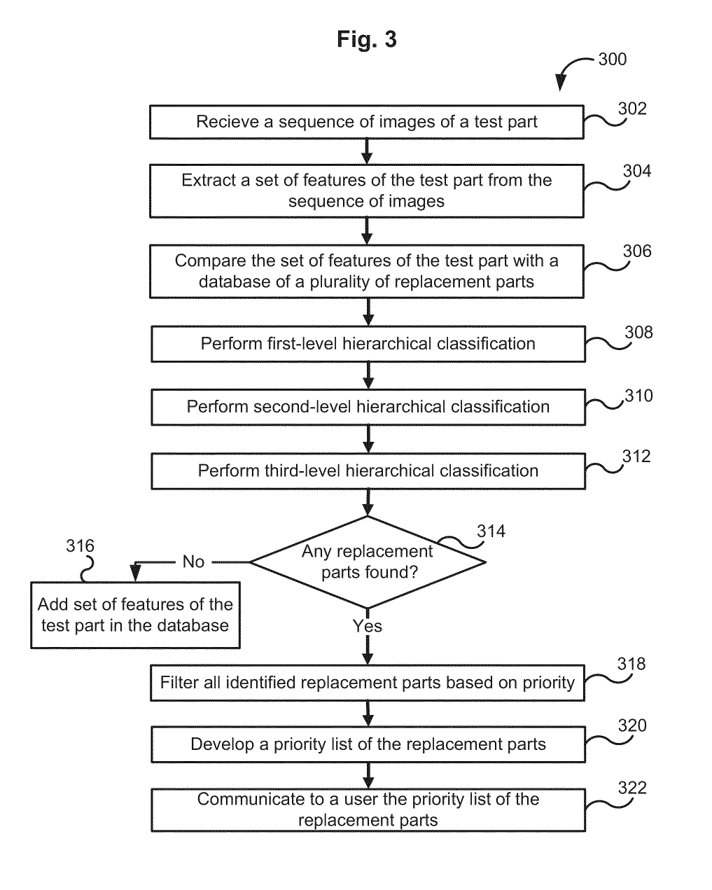

In some embodiments, a method for identifying replacement parts for a test part can include hierarchical comparison of a set of features of a test part. FIG. 3 is a schematic flow diagram of an exemplary method 300 for identifying a replacement part. The method 300 can be used with any system described herein, for example, the system 100, or a non-transitory computer readable medium capable of being executing by a computing device, for example, the computing device 130, or 430 described herein.

The method 300 includes receiving a sequence of images of a test part, at 302. The test part can include a screw, a bolt, a rivet, a nut, a washer, or any other test part, as described herein with respect to the system 100. The sequence of images can be captured using any image capture device, for example, a smart phone, a tablet, a camera, or any other image capture device, as described herein with respect to the imaging device 120 included in the system 100. The sequence of images can include a plurality of images captured from different angles to show different views of the test part. For example, the test part can be a screw and the sequence of images can include a side view of the screw showing the thread count and length of the screw, a front head view showing the type of head of the screw, and/or a bottom view showing the tip of the screw as well as the radius. In some embodiments, the sequence of images can include a video of the test part, for example, a 3-dimensional video, or a video captured from different angles.

The set of features of the test part are extracted from the sequence of images, at 304. The set of features can include a dimension, a shape, a texture, a color, a material, a thread count, a spectral characteristic, a histogram threshold, scale invariant features (e.g., Scale Invariant Feature Transform (SIFT), Speed-up-Robust Feature (SURF), etc.), keypoint features (e.g., Binary Robust Invariant Scalable Keypoints (BRISK), Fast Retina Keypoint (FREAK), Binary Robust Independent Elementary Features (BRIEF), Oriented Fast, and Rotated BRIEF (ORB), etc.), and/or any other physical or computational feature relevant to identification of the test part. In some embodiments, the test part can include a screw, a bolt, or a nut. In such embodiments, the extracted features can at least include a dimension, a shape, a material, and a thread count of the test part. In some embodiments, the sequence of images of the test part can also include an object having a known shape, dimension, color, and texture (e.g., a penny). The object can serve as a reference for extracting the set of features of the test part.

The set of features of the test part can be extracted using a computing device, for example, the computing device 130 included in the system 100, the computing device 430, or any other computing device described herein. For example, instructions can be stored on a non-transitory computer readable medium which can be executed by a computing device (e.g., the computing device 130 or 430) for extracting the set of features of the test part. In some embodiments, the set of features can be extracted using a Hough Transform. Furthermore, any number of instructions can be stored on the non-transitory computer readable medium described herein for performing any of the operations described herein.

The set of features of the test part are compared with a database of a plurality of replacement parts, at 306. The database can, for example, be stored on a computer readable medium. The database stores a set of features of the plurality of replacement parts. In some embodiments, the database can be populated by crawling a plurality of websites of suppliers of one or more of the replacement parts and scraping information corresponding to the set of features of one or more of the replacement parts from each of the plurality of websites. In some embodiments, the set of features of the replacement parts included in the database can include a shape, a texture, a color, a material, a thread count, a html link to at least one supplier, information on usability, and an image (e.g., a thumbnail image).

In some embodiments, models of the replacement parts can be trained using images of replacement parts and/or super vector features, which can be Gaussian Mixture Models (GMMs), Convolutional Neural Networks (CNNs), Radial Basis Functions (RBFS), and/or other kernels and a classifier, such as Support Vector Machines (SVMs) and/or Linear Discriminant Functions, can be constructed. The classifier can include, for example, a hierarchical classifier which can order or otherwise arrange the set of features of the replacement part into in predetermined classes or hierarchy. The set of features of the replacement parts can include information on shape, texture, color, material, thread count, a html link to at least one supplier, information on usability, and/or image (e.g., a thumbnail image). In some embodiments, the replacement parts can also be classified into hierarchical classifiers based on type in the database. For example, the replacement parts can be classified into a first-level hierarchical classification as a fastener, or another part. If the replacement part is a fastener, a second-level hierarchical classification can be performed to classify the replacement part as a fastener with a head, or a round a fastener. If the replacement part is a fastener with a head, a third-level hierarchical classification can be performed to classify the replacement part as a screw, a bolt, or a rivet. Alternatively, if the replacement part is a round fastener, the third-level classification can classify the replacement part as a nut or a washer. Further classifications can also be performed based on the set of features of the replacement parts. Classifying the replacement parts can facilitate identification of one or more replacement parts having a set of features similar to the set of the features of the test part using hierarchical comparison, as described herein.

A first-level hierarchical classification is performed, at 308. For example, the first-level hierarchical classification can determine if the test part is a fastener, or any other part. The fastener can include a fastener with a head (e.g., a screw, a bolt, or a rivet), or a round fastener (e.g., a nut or a washer).

A second-level hierarchical classification is performed, at 310. For example, if the first-level classification determined that the test part is a fastener, the second-level hierarchical classification can determine if the test part is a fastener with a head, or a round fastener. Expanding further, the test part can be a screw and the second-level classification can determine that the test part is a fastener with a head. Alternatively, the test part can be a nut, and the second level classification can determine that the test part is a round fastener.

A third-level hierarchical classification is performed, at 312. For example, the third-level hierarchical classification can determine a sub-type of the test part. Expanding further, the third-level classification can determine whether the test part is a screw, a bolt or a rivet, if the second-level classifier determined the test part to be fastener with a head. Similarly, the third-level classification can determine whether the test part is a nut or a washer, if the second-level classifier determined the test part to be a round fastener.

While not shown, further sub-level classifications can also be performed. For example, a sub-level classification can classify the replacement test part based on the set of features of the test part. For example, the test part can be a screw and a first sub-level classification can determine the material of the screw, a second sub-level classification can determine the thread count of the screw, a third sub-level classification can determine the color of the screw, and so on, not necessarily in that order.

The method determines if any replacement part is found, at 314. Expanding further, the method 300 determines if there are one or more replacement parts in the database that include a set of features which are similar to the set of features of the test part. If no replacement part having a set of features similar to the set of features of the test part is found in the database, the set of features of the test part are added to the database, at 316. In this way, the database can continue evolving to include any new replacement parts not already included in the database. In some instances, replacement parts can be found that have of set of features that are less than the set of features of the test part. In another words, the number of features of the replacement parts included in the set of features of the replacement part is less than the number of the set of features of the test part. In such instances, the remaining set of features of the test part can also be added to the database.

If one or more replacement parts are identified in the database that have a set of features similar to the set of features of the test part, than all identified replacement parts are filtered based on priority, at 318. In some embodiments, the filtering based on priority can include determining if more than one supplier of an identified replacement part is found, and selecting only a priority supplier of the identified replacement part to include in a priority list, as described herein.

A priority list of replacement parts is developed, at 320. This can include, for example, sorting the identified replacement parts to include replacement parts having a set of features that best match the set of features of the test part to be arranged on top of the priority list. For example, certain features included in the set of features of the replacement part can be more relevant or pertinent in finding a replacement for the test part. For example, the thread counts, length, and width of a test part that includes a screw (also referred to as “the test screw”) can have higher priority relative to the size or shape of the head of the test screw. Thus, replacement screws having thread counts, length, and/or width similar to the test screw will have higher priority over replacement screws that have a similar head to the test screw.

The priority list of replacement parts is communicated to a user, at 322. For example, the priority list of the identified replacement parts can be displayed to the user on a display (e.g., a monitor, a smartphone, or a tablet display). In some embodiments, only a subset of the identified replacement parts can be displayed to the user, for example, the top three identified replacement parts. In such embodiments, a drop down menu or any other option can be provided to the user to view all other identified replacement parts that are not initially displayed to the user. In addition, the user can provide an indication that a replacement part was indeed a correct replacement part. This indication can be integrated into the database and used in selecting replacement parts for future searches.

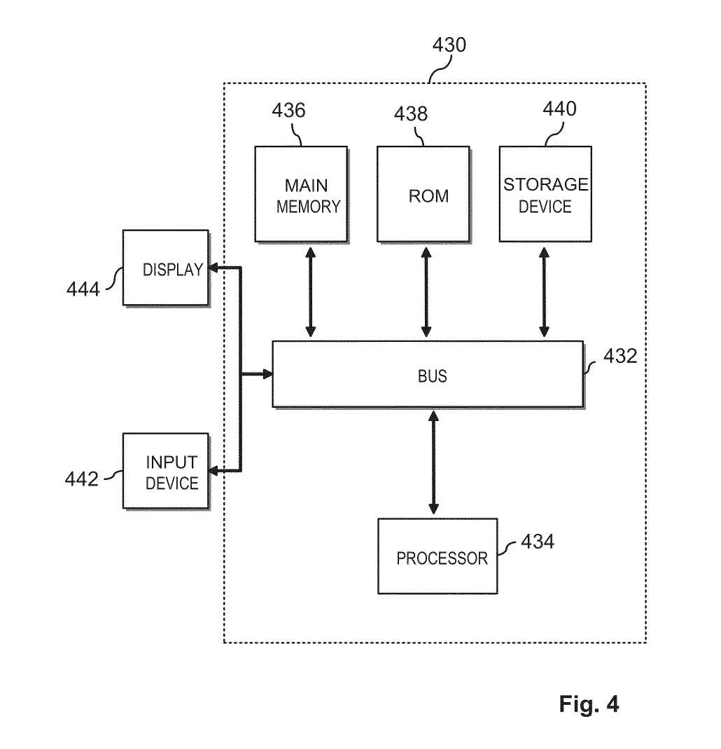

FIG. 4 is a block diagram of a computing device 430 in accordance with an illustrative implementation. The computing device 430 includes a bus 432 or other communication component for communicating information and a processor 434 or processing circuit coupled to the bus 432 for processing information. The computing device 430 can also include one or more processors 434 or processing circuits coupled to the bus for processing information. The computing device 430 also includes main memory 436, such as a random access memory (RAM) or other dynamic storage device, coupled to the bus 432 for storing information, and instructions to be executed by the processor 434. Main memory 436 can also be used for storing position information, temporary variables, or other intermediate information during execution of instructions by the processor 434. The computing device 430 may further include a read only memory (ROM) 438 or other static storage device coupled to the bus 432 for storing static information and instructions for the processor 434. A storage device 440, such as a solid-state device, magnetic disk or optical disk, is coupled to the bus 440 for persistently storing information and instructions.

The computing device 430 may be coupled via the bus 432 to a display 635, such as a liquid crystal display, or active matrix display, for displaying information to a user. An input device 442, such as a keyboard including alphanumeric and other keys, may be coupled to the bus 432 for communicating information and command selections to the processor 434. In another implementation, the input device 442 has a touch screen display 444. The input device 442 can include a cursor control, such as a mouse, a trackball, or cursor direction keys, for communicating direction information and command selections to the processor 434 and for controlling cursor movement on the display 444.

According to various implementations, the processes and methods described herein can be implemented by the computing device 430 in response to the processor 434 executing an arrangement of instructions contained in main memory 436. Such instructions can be read into main memory 436 from another non-transitory computer-readable medium, such as the storage device 440. Execution of the arrangement of instructions contained in main memory 436 causes the computing device 430 to perform the illustrative processes described herein. One or more processors in a multi-processing arrangement may also be employed to execute the instructions contained in main memory 436. In alternative implementations, hard-wired circuitry may be used in place of or in combination with software instructions to effect illustrative implementations. Thus, implementations are not limited to any specific combination of hardware circuitry and software.

Although an example computing device has been described in FIG. 4, implementations described in this specification can be implemented in other types of digital electronic circuitry, or in computer software, firmware, or hardware, including the structures disclosed in this specification and their structural equivalents, or in combinations of one or more of them.

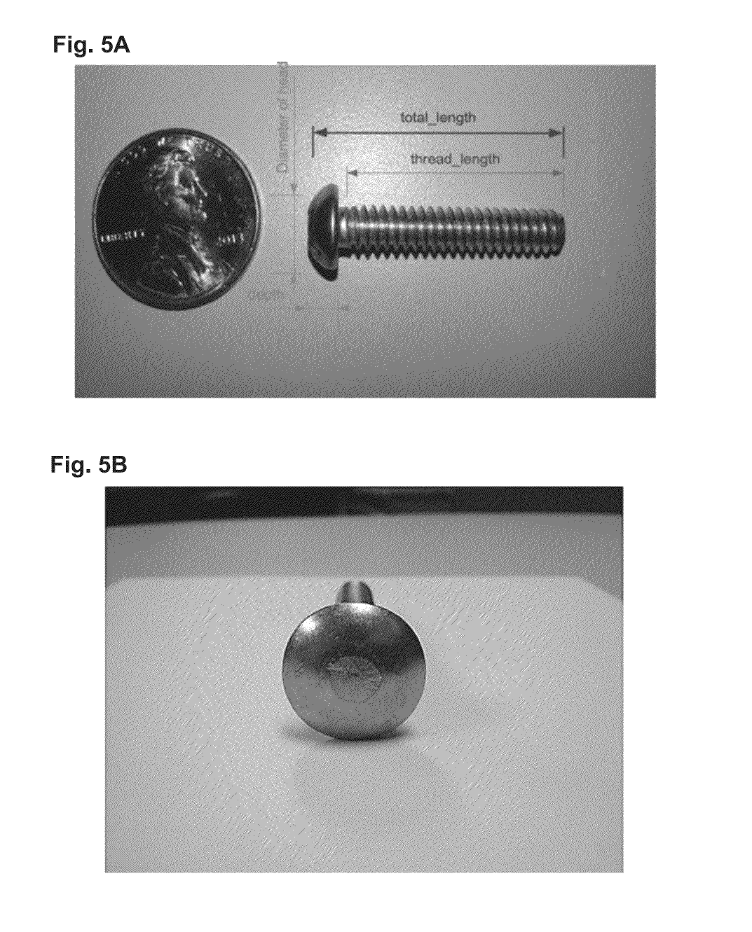

FIGS. 5A and 5B are exemplary images of a test part which includes a blunt head screw. The images can be used to extract the set of features of the screw using any embodiments of the system and methods described herein, for example, the system 100, or the methods 200, or 300. Expanding further, FIG. 5A is a first image of a screw taken from the side (i.e., a top-down aerial view) to show the thread count, thread length, total length, diameter of head, and depth of the head of the screw. A penny is also included in the first image as a reference object. In some embodiments, a circle Hough Transform is performed on the penny to extract the set of features of the penny for use as reference features for the screw. A first-level hierarchical classification is performed on the first image to determine if the test part (i.e., the blunt head screw) is: (1) a part with a head (i.e., a screw or a bolt); (2) a round part (i.e., a washer, a nut, etc.), or; (3) any other object.

Based on the first-level classification, the system or method can determine that the test part is a part with a head. Furthermore, the system or method can also determine the diameter of the head of the screw, the total length of the screw, the depth of the screw, the length of the threaded portion of the screw, and the diameter of the base of the screw. A line Hough Transform can be used to determine the thread count of the screw. Preprocessing of the image can also be performed on the image to obtain before extracting the set of features. Such preprocessing can include, for example, converting the image from color into a binary image (e.g., black and white or grayscale) which can make it easier to apply the transforms.

In some embodiments in which the test part is a washer or nut, the first-level classification can classify the test part as a round part. Furthermore, the first level classification can also determine the inner and outer diameter of the washer or nut. In such embodiments, the outer diameter can be determined using distance from one flat to the adjacent flat side, and/or distance from one corner to another corner (e.g., using the Whitworth system).

FIG. 5B is a second image of the blunt head screw captured from the front to show the head of the screw. This can be used to determine the head type of the screw. For example, in some embodiments, a second-level classification can determine if the head type of the screw is round, hex, or square. A third-level classification can determine a sub-type of the screw. For example, the third-level classification can determine if the screw is dome or flat, and if the drive type is Philips, flat, Allen, torx 6, security torx 6, etc. The third-level classification or any sub-level classification can also determine a length of the major axis of the drive of the screw. Various strategies can be used to determine the major axis of the drive of the screw. For example, for a Philips head, the drive type is a cross, so the drive type includes two major axes which are the same length. For a flat screw, the major axis is a single axis. For a torx 6 drive type which includes a symmetric star, the major axis can be from any corner to an adjacent corner. For an Allen 6 (hex socket) drive type, the hex is symmetric and the major axis can be from any corner to an adjacent corner. Similarly, for a security hex 6 drive type which also includes a symmetric star, the major axis can be from any corner to an adjacent corner. Since the test part shown in FIGS. 5A and 5B is a blunt head screw (FIG. 5B) which does not include a drive, no major axis will be extracted for the screw.

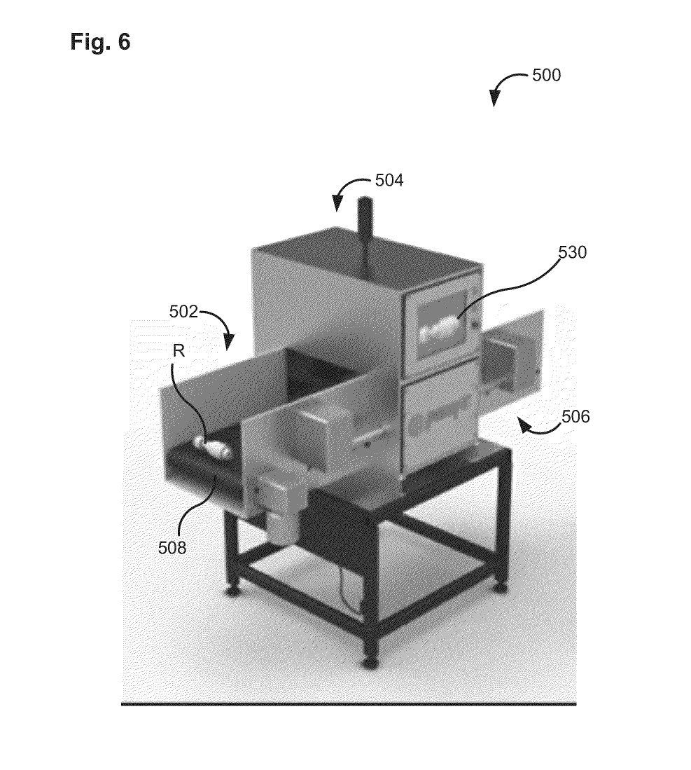

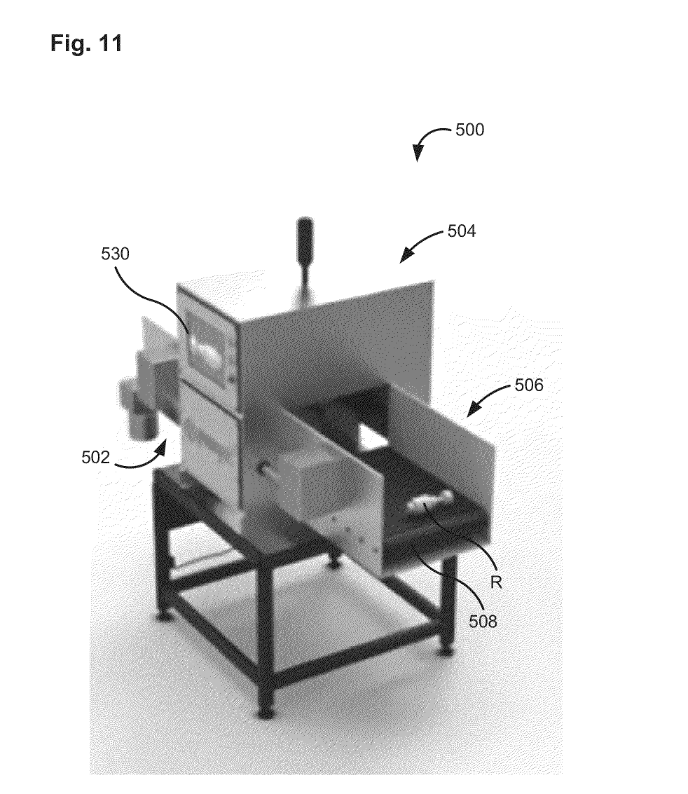

FIGS. 6-11 show an automated machine 500 for capturing images of a batch of replacement parts which can be uploaded to a computing device (e.g., the computing device 130 described herein) to extract the set of features of the batch of the replacement parts. The machine 500 includes a loading portion 502, an imaging portion 504, and a recovery portion 506. The machine 500 also includes a conveyor belt 508, a plurality of imaging devices 520a-f, and optionally, a computing device 530.

As shown in FIG. 6 a replacement part R included in a batch of replacement parts can be disposed on the conveyor belt 508 in the loading portion 502 of the machine 500. The conveyor belt 508 can be mounted on rollers and can be configured to move continuously through the machine 500 to carry the replacement part R from the loading portion 502, to the recovery portion 506 through the imaging portion 504. The conveyor belt 508 can be formed from a substantially transparent material such as, for example, polycarbonate, acrylic, plastic, any other suitable material or a combination thereof. This can allow viewing of the replacement part R from below.

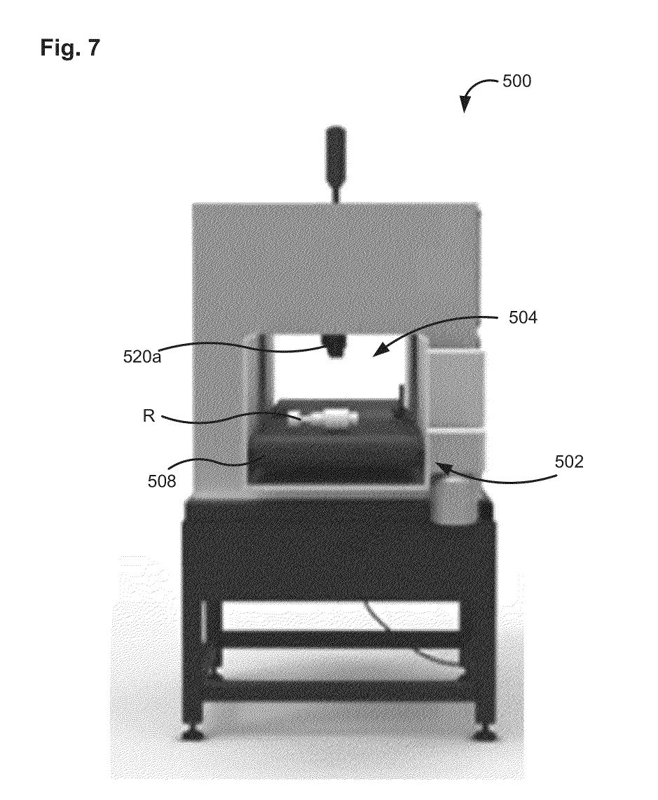

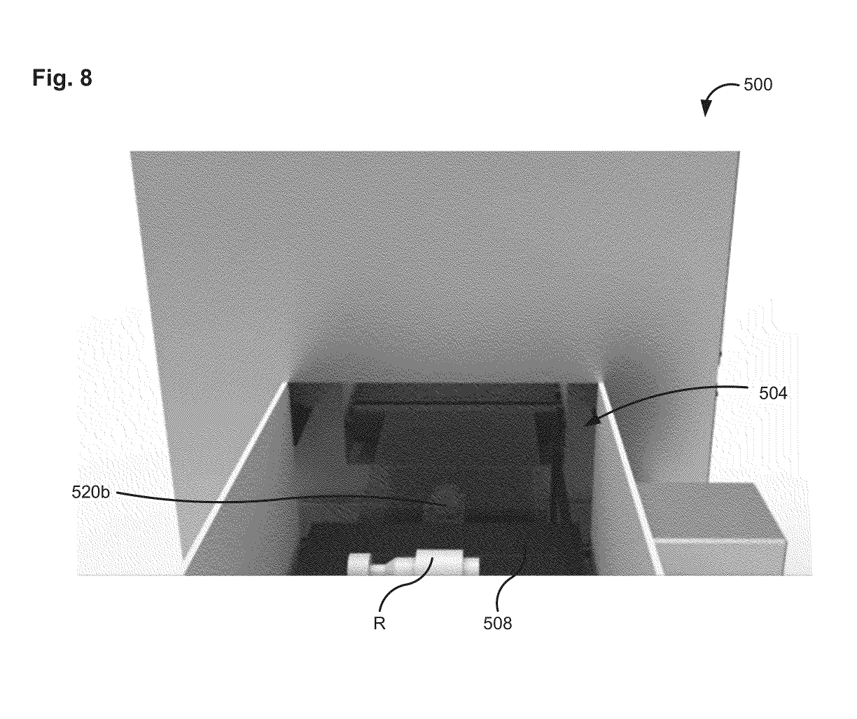

FIG. 7 shows the replacement part R traveling on the conveyor belt 508 into the imaging portion 504. A first imaging device 520a (e.g., a camera) is disposed and oriented in the imaging portion 504 to capture an image of the replacement part R from above the replacement part R. As shown in FIG. 8 a second imaging device 520b is disposed in the imaging portion 504 below the conveyor belt 508. The second imaging device 520b is configured to capture an image of the replacement part R from below, through the conveyor belt 508.

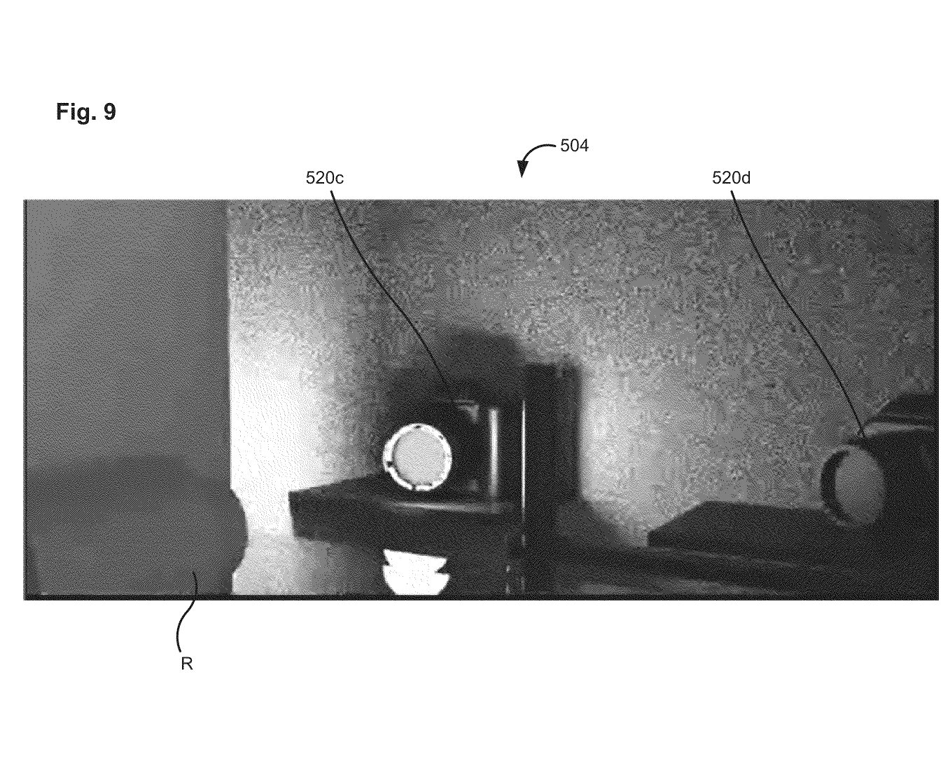

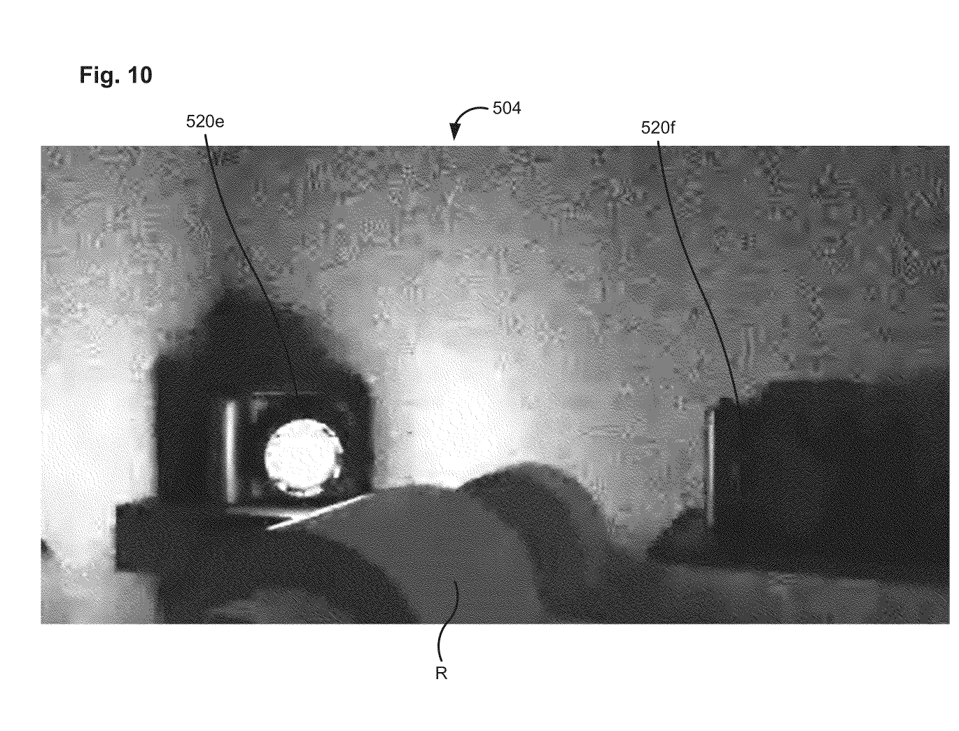

FIG. 9 shows a third imaging device 520c and a fourth imaging device 520b disposed in the imaging portion 504. The third imaging device 520c and the fourth imaging device 520f are disposed and oriented to capture images of the front of the replacement part R from two different angles. Furthermore, as shown in FIG. 10 a fifth imaging device 520e and a sixth imaging device 520f are also disposed in the imaging portion 504, which are disposed and oriented to capture images of the back of the replacement part R from two different angles. In other words, each of the imaging device 520c-f can be disposed in the imaging portion 504 so as to capture images of the replacement part R from four different angles around the replacement part R. For example, the third imaging device 520c can be oriented at a 45 degree angle relative to a central axis of the replacement part R and in the same plane as the central axis. The fourth imaging device 520d can be dispose at a 135 degree angle, the fifth imaging device 520e can be disposed at a 225 degree angle, and the sixth imaging device 520f can be disposed at a 315 degree angle with respect to the central axis of the replacement part R in the same plane. In this manner, the imaging devices 520a-f in combination can capture 360 degree images of the replacement part R.

While not shown, the imaging portion 504 can also include sensors configured to detect that a replacement part R is present in the imaging portion 504, and to trigger the imaging devices 520a-f to capture images of the replacement part R. Suitable sensors can include, for example, motion sensors, weight sensors, laser sensors, infrared sensors, any suitable sensors or combination thereof. In some embodiments, the machine 500 can be configured such that each of the imaging devices 520a-f capture images of the replacement part R simultaneously. In some embodiments, the machine 500 can be configured such that the imaging device 520a-f capture images of the replacement part R sequentially. The imaging portion 504 can also include lighting to allow the images to be captured with a predetermined brightness and/or contrast.

Once the images of the replacement part R are captured, the replacement part R can continue travelling on the conveyor belt 508 through the imaging portion 504 and into the receiving portion 506 where it can be collected or otherwise removed from the conveyor belt 508. The conveyor belt 508 can be configured to run continuously such that a batch of replacement parts can be loaded on the machine 500 one after the other and the imaging devices 520a-f can continuously capture images of the replacement parts. The machine can be configured to assign ID's to each replacement part imaged such that the images can be correlated to the correct replacement part.

A computing device 530 can optionally be included in the machine 500. In some embodiments, the computing device 530 can be substantially similar to the computing device 130 described herein. The computing device 530 can be configured to receive the images of the batch of replacement parts and extract the set of features of the replacement parts included in the batch. The set of features of the batch of replacement parts can be used to build a database of replacement parts or add the set of features to a preexisting database. In some embodiments, the computing device can be a remote server disposed remotely from the machine 500. In such embodiments, the machine 500 can be configured to store and/or transfer data to the remote computing device for extracting the set of features. For example, the machine 500 can include Wi-Fi, wired internet connection (e.g., cable or DSL), BLUETOOTH®, USB 2.0, IEEE firewire, any other suitable technology for communicating the captured images to the remote computing module.

In some embodiments, the machine 500 can also include a display, for example, to view the captured images of the replacement part. In this manner, a user can determine if the captured images of the replacement part are of sufficient quality for extracting the set of features. In some embodiments, the machine 500 can also include an input, for example, a touch screen or a keyboard to control one or more parameters of the machine. For example, the input can be used to control the speed of the conveyor belt, lighting intensity, camera shutter speed, or any other parameters of the machine 500.

In some embodiments, the machine 500 can also be used to capture images of a test part. The images of the test part can then be used to extract the set of features of the test part for comparison with the database of replacement parts to identify a best match replacement part for the test part. Capturing images of the replacement parts as well as the test part using the machine 500 can ensure that a similar set of images is captured for the test part to extract its set of features, relative to the set of images used to extract the set of features of the replacement parts which are used to populate the database. This can enhance the fidelity of the replacement part identification process by reducing or otherwise eliminating any errors due to low quality images associated with human error.

Implementations described in this specification can be implemented in digital electronic circuitry, or in computer software, firmware, or hardware, including the structures disclosed in this specification and their structural equivalents, or in combinations of one or more of them. The implementations described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources. The term “data processing apparatus” or “computing device” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings and tables in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for identifying replacement parts, the method comprising;
receiving a sequence of images of a test part;
extracting a set of features of the test part from the sequence of images, the set of features including at least one of a dimension, a shape, a texture, a color, a material, a thread count, a spectral characteristic, a histogram threshold, scale invariant features, and keypoint features;
comparing the set of features of the test part with a database of a plurality of replacement parts, the database storing a set of features of each of the plurality of replacement parts;
identifying at least one replacement part in the database having a set of features similar to the set of features of the test part;
filtering all identified replacement parts based on priority;
developing a priority list of replacement parts; and
communicating to a user the priority list of replacement parts.

2. The method of claim 1, wherein the extracted set of features includes a dimension, a shape, and a material.

3. The method of claim 2, wherein the test part is at least one of a screw, a nut, and a bolt, the extracted set of features further including a thread count.

4. The method of claim 1, wherein an object having a known shape, dimension, color, and texture is included in the sequence of images of the test part, the object serving as a reference for extracting the set of features of the test part.

5. The method of claim 4, wherein the set of the features of the test part are extracted using a Hough Transform.

6. The method of claim 1, further comprising:
populating the database of the set of features plurality of replacement parts, the populating comprising:
crawling a plurality of websites of suppliers of one or more of the replacement parts; and
scraping information corresponding to the set of features of one or more of the replacement parts from each of the plurality of websites.

7. The method of claim 6, wherein the set of features of the replacement parts comprise at least one of a shape, a texture, a color, a material, a thread count, a html link to at least one supplier, information on usability, and an image.

8. The method of claim 6, further comprising:
determining the set of features of the identified replacement part stored in the database are less than the set of features of the test part;
adding a remaining set of features of the test part to the database.

9. The method of claim 1, wherein the comparing includes a hierarchical comparing of the set of features of the test part to the database of the set of features of the replacement parts.

10. The method of claim 9, wherein the test part is a fastener with a head or a round fastener, the fastener with a head including at least one of a screw, a bolt, and a rivet, and the round fastener including at least one of a washer and a nut, the hierarchical comparison comprising:
determining if the test part is a fastener;
determining if the test part is a fastener with a head or a round fastener;
determining if the test part is at least one of the screw, bolt and rivet, if the test part is identified as a fastener with a head; and
determining if the test part is at least one of the washer or the nut, if the test part is identified as a round fastener.

11. The method of claim 1, wherein the filtering based on priority comprises:
determining if more than one supplier of an identified replacement part is found;
selecting only a priority supplier of the identified replacement part to include in the priority list.

12. The method of claim 11, wherein the developing a priority list of replacement parts comprises;
sorting the identified replacement parts to include identified replacement parts having a set of features that best match the set of features of the test part to be arranged on top of the priority list.

13. A system for identifying replacement parts, comprising:
an imaging device operable to capture a sequence of images of a test part, the imaging device operably coupled to a computing device;
wherein the computing device is configured to:
store a database of a set of features of a plurality of replacement parts;
receive the sequence of images of the test part from the imaging device;
extract a set of features of the test part from the sequence of images, the features including at least one of a dimension, a shape, a texture, a color, a thread count, a spectral characteristic, a histogram threshold, scale invariant features, and keypoint features;
compare the set of features of the test part with the database of the set of features of each of the plurality of replacement parts;
identify at least one replacement part in the database having a set of features similar to the set of features of the test part;
filter all identified replacement parts based on priority;
develop a priority list of replacement parts; and
communicate to a user the priority list of replacement parts.

14. The system of claim 13, wherein the test part is at least one of a screw, a nut, and a bolt, the extracted set of features comprising:
a dimension, a shape, a material, and a thread count.

15. The system of claim 13, wherein to populate the database of the plurality of replacement parts, the computing device is further configured to:
crawl a plurality of websites of suppliers of the replacement parts; and
scrape information corresponding to the set of features of the replacement parts from each of the plurality of websites.

16. The system of claim 13, wherein the computing device compares the set of features of the test part with the database of the set of features of each of the plurality of replacement parts using hierarchical comparison.

17. A non-transitory computer readable medium for identifying at least one replacement part for a test part, having instructions stored thereon that, when executed by a computing device, causes the computing device to perform operations comprising:
receiving a sequence of images of the test part from an imaging device;
extracting a set of features of the test part from the sequence of images, the set of features including a dimension, a shape, a texture, a color, a thread count, a spectral characteristic, a histogram threshold, scale invariant features, and keypoint features;
comparing the set of features of the test part with a database of a plurality of replacement parts stored on the computer readable medium, the database storing a set of features of each of the plurality of replacement parts;
identifying at least one replacement part in the database having a set of features similar to the set of features of the test part;
filtering all identified replacement parts based on priority;
developing a priority list of replacement parts; and
communicating to a user the priority list of replacement parts.

18. The non-transitory computer readable medium of claim 17, wherein an object having a known shape, dimension, color, and texture is included in the sequence of images of the test part, the object serving as a reference for extracting the set of features of the test part.

19. The non-transitory computer readable medium of claim 18, wherein the set of the features of the test part are extracted using a Hough Transform.

20. The non-transitory computer readable medium of claim 19, wherein the comparing includes hierarchical comparison of the set of features of the test part with the database of the replacement parts.
